(19) United States
(12) Patent Application Publication
(10) Pub. No.: US 2002/0133371 A1
(43) Pub. Date: Sep. 19, 2002

(54) Automated mortgage fraud prevention method and system

(76) Inventor: James A. Cole, Carp (CA)

Correspondence Address: PEARNE & GORDON LLP, 526 SUPERIOR AVENUE EAST, SUITE 1200, CLEVELAND, OH, 44114-1484, US

(21) Appl. No.: 10/056,391

(22) Filed: Jan. 24, 2002

(30) Foreign Application Priority Data
Jan. 24, 2001 (CA) 2,332,255

(51) Int. Cl. G06F 17/60

(52) U.S. Cl. 705/1

(57) ABSTRACT

An automated mortgage fraud prevention method is disclosed. The method comprises the steps of: maintaining a database in a computer system, the database containing data regarding a number of real properties, providing information on a mortgage application to the computer system, and analyzing the provided information and the data in the database to search for any abnormal situation therein, which may constitute a potential mortgage fraud scheme, wherein, when the abnormal situation is flagged, measures can be taken to prevent a mortgage fraud from occurring. The database includes an identification data, a valuation data, and a historical market activity data associated with each real property. An automated mortgage fraud prevention system is also disclosed.

### FIELD OF THE INVENTION

The present invention relates generally to mortgage fraud prevention. More particularly, the invention relates to an automated detection of situations indicating potential fraud in a residential mortgage lending process.

### BACKGROUND OF THE INVENTION

Mortgage fraud is a clearly undesirable but pervasive problem in the property market. Such fraud typically results in the granting of loan funds secured by a mortgage where the normal process of lending due diligence is circumvented through individual deception or fraudulent collusion between parties in the lending process. While mortgage fraud occurs in a small percentage of the overall number of transactions in the industry, the losses associated with such fraud amount to significant losses to financial institutions. Fraudulent activity tends to have certain repetitive patterns associated with it and typically leaves behind trails comprising certain types of data.

Mortgage fraud takes many forms. “Self-serving” fraud may be defined as fraud perpetrated by single potential borrowers in order to secure loans, which they intend to pay back. “Malicious” frauds may be defined as those where the clear goal is to take the money without any intention of repayment. Even worse are organized schemes where a series of loans based on fraud is the goal. All these types may be characterized by certain repetitive patterns.

Unfortunately at some point the loan does not get repaid and the financial institution must then attempt to realize on its security. If the property was over valued at the time the loan was given, the bank will be under-secured and will be left with a shortfall when the property is sold.

In the case of these more serious fraud schemes there tend to be some general trends. There is typically collusion between some parties in the process. These tend to involve property sales, rather than refinances. They tend to happen with new clients, or alternatively, fraud tends to be less of a factor when dealing with long-term clients. Repetitive behaviour is also present with fraudulent activities involving the same properties, participants and names. Frauds generally do not happen as much with owner occupied properties.

Sophisticated frauds schemes also tend to be perpetrated across many different lending institutions, making it difficult for any single organization to deal successfully with the problem. It is an industry concern.

In many cases, these frauds are actualized through the vehicle of “flipping” properties between parties, where the value of the property artificially rises dramatically. In some cases, the property will change hands on the same day (or in a relatively short time) at markedly different values, with loans made based on inflated values. These inflated values may be substantiated through a variety of methods. In many cases, there may be separate transactions involving multiple lenders.

The problem of mortgage fraud has not been solved. It is known in the art that lender representative training and compliance with stated lending policies help to alleviate the problem. Property searches can be conducted regarding specific properties to determine transaction histories related to specified properties.

However, mortgage fraud is generally recognized as an industry-wide problem and attempts by any single institution have failed to address the problem. Lender representative training and increased due diligence cannot properly assess information related to properties and borrowers where multiple lending institutions are involved in multiple transactions. Property searches cannot provide information related to queries made in relation to properties that do not form the basis of a registered transaction. Furthermore, property searches are property-specific and do not provide information about communities or cities. As such, they cannot provide comparative data with which to use in fraud detection. In addition, these methods are ineffective when the person charged with conducting the due diligence or property search colludes with the fraudulent activity.

Accordingly, there is a need to provide a method and system for automatically detecting any potential fraud situation during the process of a residential mortgage application, thereby enabling the mortgage lending institution to take measures for preventing any potential mortgage fraud schemes, which may occur.

### SUMMARY OF THE INVENTION

According to one aspect of the present invention, there is provided a method of preventing a mortgage fraud by using a computer system during the process of a mortgage application, where a real property is presented as collateral by the mortgage applicant. The method comprises the steps of: (a) maintaining a database in the computer system, the database containing data regarding a plurality of real properties, the data including an identification, a valuation, and a historical market activity associated with each real property; (b) providing information on the mortgage application to the computer system; and (c) analysing the information provided from the mortgage application and the data in the database to search for any abnormal situation therein, which may constitute a potential mortgage fraud scheme; (d) wherein, when the abnormal situation is flagged, measures can be taken to prevent a mortgage fraud from occurring.

According to another aspect of the present invention, there is provided an automated mortgage prevention method by using a computer system. The method comprises the steps of: (a) maintaining a database in the computer system, the database containing data regarding a plurality of real properties, the data including an identification data, a valuation data, and a data of historical market activities associated with each real property; (b) analysing the data to flag abnormal situations therein, which constitute a potential mortgage fraud; and (c) providing a list of real properties containing flags. The method can further comprises a step of distributing the list of real properties containing the flags to a plurality of mortgage lenders.

According to another aspect of the invention, there is provided a computer system for preventing a mortgage fraud. The system comprises (a) a database containing a data regarding a plurality of real properties, the data including an identification data, a valuation data, and a historical market activity data associated with each real property; (b) means for analysing the data to search for an unacceptable situation therein, which may constitute a potential mortgage fraud; and (c) means for providing a list of real properties containing flags.

The system further comprises a plurality of mortgage lenders' systems communicatively connected with the system via a communications network. Information associated with a loan application is provided from the mortgage lender to the system, and the system further comprises (a) means for analysing the information provided from the loan application by the lender and the data in the database to search for an unacceptable situation therein, which may constitute a potential mortgage fraud scheme; and (b) means for informing the corresponding mortgage lender of the analysis result, when any unacceptable situation is flagged, thereby enabling the lender to take measures to prevent a mortgage fraud from occurring.

The computer system can further include a plurality of real property-related organizations via a communications network for exchanging relevant information.

According to another aspect of the present invention, there is provided a method of preventing a mortgage fraud during the process of a mortgage application, where a real property is presented as collateral. The method comprises the steps of: (a) receiving information on a mortgage application from a mortgage lender; (b) providing the received information to a computer system, the computer system having a database containing data regarding a plurality of real properties, the data including an identification, a valuation, and a historical market activity associated with each real property; (c) analyzing the information to flag abnormalities; and (d) sending any flag to the mortgage lender.

A further understanding of other aspects, features, and advantages of the present invention will be realized by reference to the following description, appended drawings and accompanying drawings.

### BRIEF DESCRIPTION OF THE DRAWINGS

The embodiments of the invention will be described with reference to the accompanying drawings, in which:

FIG. 1 illustrates a basic processing of mortgage applications where a collateral property is involved;

FIG. 2 schematically shows a way how the present invention is applied to the basic mortgage application process in FIG. 1;

FIG. 3 is a schematic representation of a mortgage fraud detection system according to one embodiment of the invention; and

FIGS. 4 to 8 are illustrations of screens depicting property data indicating a condition for a red flag as defined by financial institution parameters.

### DETAILED DESCRIPTION OF THE PREFERRED EMBODIMENT(s)

The present invention relates to mortgage fraud prevention, and is specifically designed to automatically detect situations implying any potential mortgage fraud scheme during the process of a residential mortgage application, where a real property is presented as collateral by the mortgage applicant. Accordingly, the invention provides a separate, or complimentary method and/or system to any residential mortgage processing. For example, the invention can be embodied in combination with or in relation to the method or system disclosed in co-pending Canadian Application No. 2,363,366 and U.S. application Ser. No. 10/003,368, which are filed in the name of the same applicant as this application. The disclosures of the Canadian and U.S. applications are incorporated herein by reference.

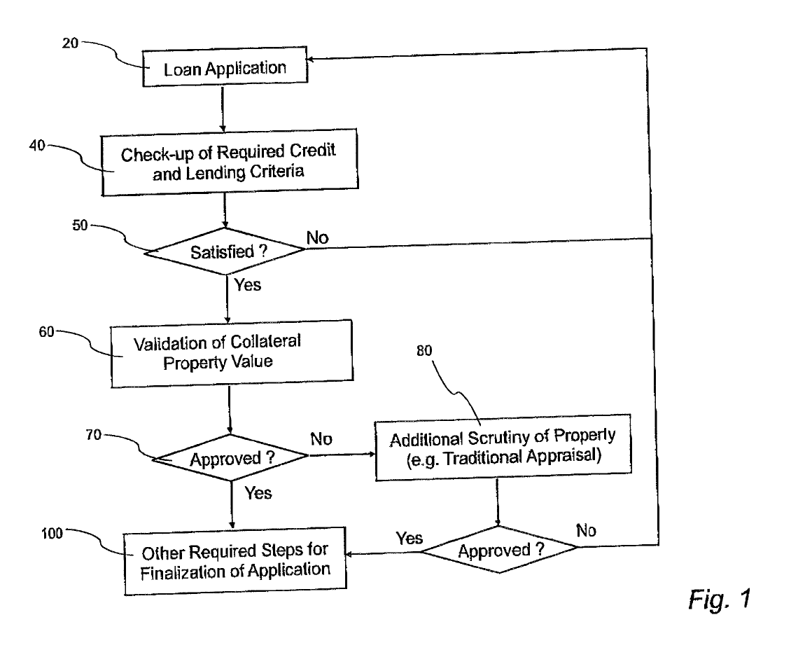

In FIG. 1, there is generally shown a basic processing for a loan (mortgage) application, where the method and system of the invention can be applied. As illustrated in FIG. 1, in general, the mortgage application 20 goes through a check of all required credit and lending criteria as in the step 40. Once the lender is satisfied with the credit worthiness of the applicant, then the validation and valuation process for the collateral real property is carried out as in the step 60. If the result of the validation and valuation is reasonable, as compared to a requested loan amount of the application, the application can be approved and then other required steps for finalizing the application may be applied as in the step 100. Even if the resultant valuation of the collateral property is unfavorable, an additional scrutiny of the property may be processed, for example by using a traditional appraisal as shown in the step 80 of FIG. 1. Likewise, if the result of scrutiny is satisfactory, the application can be approved.

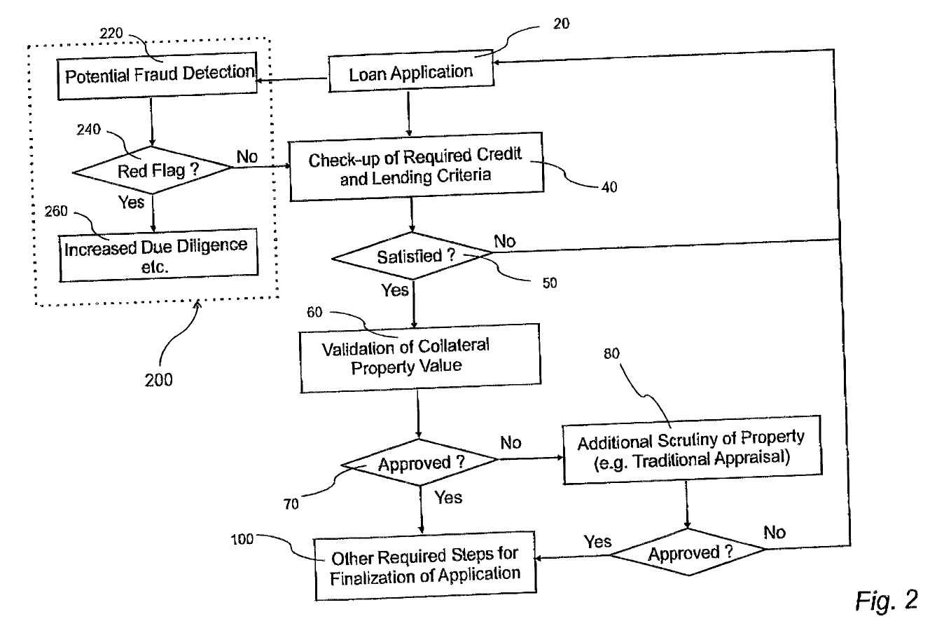

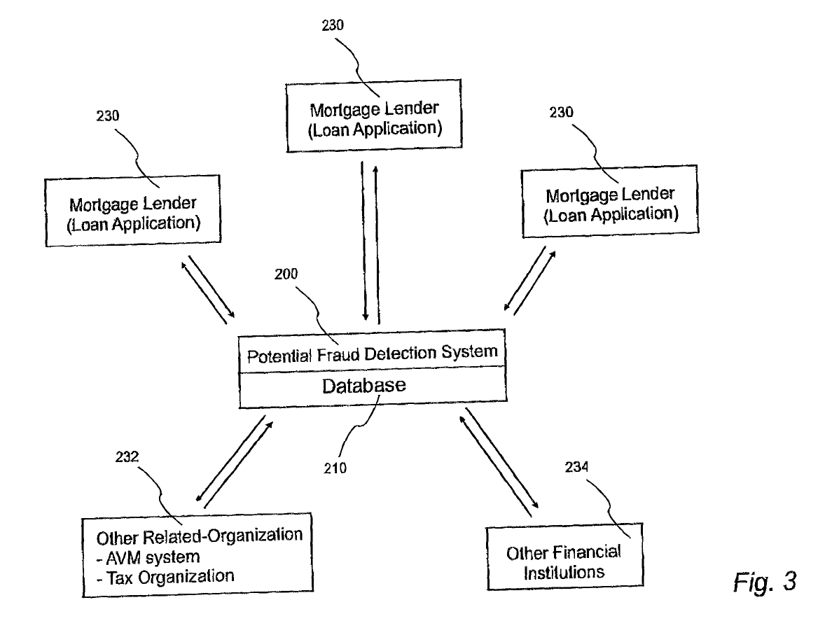

According to one embodiment of the present invention, an automated mortgage fraud prevention method and system are provided. FIG. 2 shows a way that the method and system, which is generally denoted by a reference numeral 200, is applied to the mortgage lending process of FIG. 1. As illustrated, the method 200 automatically flags situations 240 indicating potential fraud before the loan is funded, thereby allowing the lender to do increased due diligence 260 where it may be warranted. FIG. 3 shows a schematic representation of a mortgage fraud detection system according to another embodiment of the invention. The details of the method and system will be described hereinafter.

The system and method of this embodiment are devised to automatically detect a possible mortgage fraud. In each market, it traps certain details of each mortgage loan application made within that market, ideally from all active lenders. In order to provide such a level of automation, the entire system is envisioned as, for example, a web-based database, with automated electronic feeds from the lenders (or clients) using the system, and automated responses, as illustrated in FIG. 3.

The central database 210 of the system will be detailed below.

The database 210 contains all information regarding a number of real properties, and the information includes an identification data of each property, a valuation data, and also a historical sales data associated with each real property.

The database 210 contains all of the incoming transactions, and scrutinizes them against a backdrop of independent market data, which has been structured for this purpose.

The system database 210 requires a file of property records, where ideally there will be one record for each relevant real property within the marketplace, to be referenced each time a mortgage application is made using that property as collateral.

For each property, the identification data contains for example the following information; 1. A property address, 2. A property code—some classification of property type, which is generally made for tax purposes, 3. A current property value, which can be derived from an AVM system or tax assessment materials 232 in FIG. 3, 4. An owner name, 5. An owner address, 6. Municipality or geographic neighbourhood, and any other required information.

The term AVM (“Automated Valuation Model”) system applies in general to a broad class of computer systems that can produce valuations of the current market value of real properties, including residential properties. These AVM systems are quite complex in their own right, and typically involve large databases of property and sales related information.

As noted above, the system database 210 needs to contain information regarding historical market activities of each real property, for example, historical sales-related data. Public registries are constantly updated with details of all changes of ownership of residential properties, and this is the preferred source of raw data for the system sales records. Many transactions reported will not represent a complete transfer of ownership.

For example, sales-related data includes information on each real property as follows: 1. A property address, 2. A date of sale, 3. A sale price, 4. A 20 seller name, 5. A purchaser name, 6. A neighbourhood of property, 7. An estimated property value, 8. An assigned property code, 9. A consistent Sale Flag, 10. The Number of Days from most recent previous sale, 11. Amount difference between the current sale and the most recent previous sale, and other appropriate information.

A loan (mortgage) application to be analyzed in the system can include the following information; 1. A property address, 2. A date of sale, 3. A client (a lender name), 4. A client department, 5. A declared market value (declared property value), 6. A transaction type, 7. A requested loan amount, 8. A loan-to-value required for the lender's policy, 8. An applicant name, 9. A seller name, 10. Names of other participants in the contemplated transaction (such as a broker or a lawyer), 11. A neighbourhood, and 12. A contact point for any notification (such as an email address).

According to one embodiment of the invention, the database 210 maintains a list of suspicious names and its related information. For example, the suspicious name includes a participant who has been involved in known cases of fraudulent activities. The list of suspicious names can be continuously or regularly updated whenever any possible mortgage fraud situation is detected in the system, and any fraudulent activity is reported in the property market.

The data processing in the system will be detailed below.

One important part of this data process is the ability to match properties, sales and names cleanly, using some matching identification. In most cases, the only possible property match is by address, and therefore, address normalizing is necessary. The process can also involve manual corrections to match sales and existing properties.

Another important aspect to the method and system is keeping data details current, reflecting changes in property and markets. Accordingly, the database 210 of the system 200 is updated continuously or regularly.

Referring to FIGS. 2 and 3, in this embodiment, mortgage application details are intended to be automatically and electronically transmitted from lenders' system 230 as they are entered into lenders systems. For example, an XML standard definition, with transmission via the Internet, can be utilized, although the same data details specification can be entered and communicated to the system 200 via several other modes, including fixed communication links, or direct data entry.

A transaction for each mortgage application is processed in the following manner, as schematically illustrated in FIG. 3:

1. Transaction data is sent from a lender system 230 in a standardized format, and received and saved in the central system 200.

2. The property address is normalized and matched to the property and sales databases.

3. The names within the transaction are normalized.

4. Processing is carried out to determine whether any red flags conditions should be reported back to the lender/client, taking into account any customized requirements for the client.

5. If any red flag conditions are determined, for example an electronic message will be immediately sent back to the client/lender, in whatever medium and with any specific process steps that may be in place for that lender.

6. The updated and edited mortgage application details are stored in the central database 210.

Ongoing sales information reflecting recent market sales should be fed into the system as quickly as possible. In practise, this typically involves receiving sales data in bulk electronic form and processing it to edit and add the necessary data components necessary to merge it cleanly into the central database.

It is quite possible that sales data will become available for properties for which there is no corresponding property record, particularly for new properties. Any implementation must account for this and include provisions to add property records when necessary.

When a sales record is matched to a property record, processing must handle updating the property records to reflect the latest owner information.

Data processing necessary for each new sales record encompasses the following steps:

1. Normalize the property address, and any names.

2. Match the record to the associated property record.

If found, assign neighbourhood and property type data from the property record. In addition, the property record should be updated with most recent owner information.

If not found, a new property record has to be created, including all of the background processing necessary (GIS based). A manual check can be part of this stage, to ensure that the address normalization is correct.

3. Once associated with a property record, set the consistent flag for the new record.

4. Scan through any other sales records for this property, and set the number of days from most recent previous sale, and amount difference between the current sale and the most recent previous based on the most recent previous record if found.

The data regarding each property can be developed and maintained based on a separate feed of “raw” property data. The processing necessary to set up each property record includes:

1. Normalizing the property address.

2. Normalizing owner names, and owner addresses.

3. Assigning the geographic classifications, specifically neighbourhood classifications. This may be done through geocoding through a GIS.

4. Assigning property value based on whatever mechanism is used.

On a regular basis, the property values should be updated. These values could be derived from an associated AVM, which can be updated often, or even in “real-time”. An alternative but valid source of useful property values for this purpose is tax assessments, which are typically released at regular intervals (i.e. annually).

Red flags or potential fraud situations may be based on an analysis of several patterns consistent with known cases of fraudulent activity. They may also be based on detecting similar patterns in the data associated with a specific property in a specific neighbourhood. Red flags are intended to highlight specific situations allowing lenders to apply increased due diligence where it is warranted. In practise, each individual lender can define its own process to follow when a loan application is flagged.

It is noted that any pattern of data can occur in legitimate circumstances, and that red flags cannot be taken to indicate that fraud actually exists. In addition, the absence of any red flags cannot guarantee that any transaction is completely legitimate. Finally, the necessary underlying data may not be available in all cases. Nevertheless, the very nature of these red flags, derived out of a system and database maintained specifically for this purpose, offers a unique and valuable additional toolkit for financial institutions or mortgage lenders.

Examples of the types of red flags, or possible fraud situations are as follows:

Unusual Market Activity: It is quite common to receive multiple applications for the same property, many times coming from different lenders. Multiple applications themselves are not a problem. However, if the declared value on multiple queries of the same property are significantly different, a flag is generated.

For each mortgage application, the property value is compared against any other mortgage application records found for the property. If this value differs from the declared property values on any other applications by more than the lender's flip definition criteria, this flag will be raised.

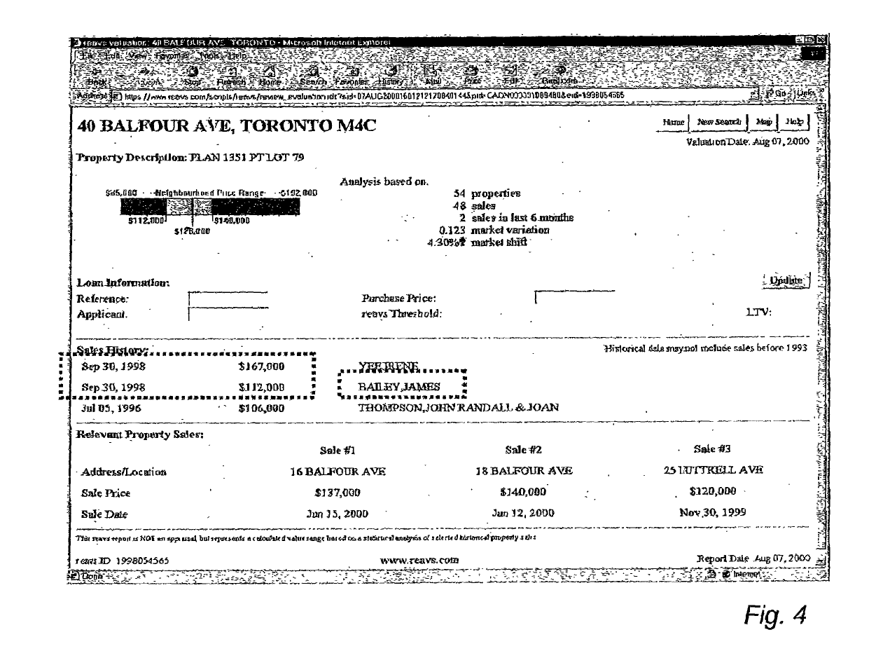

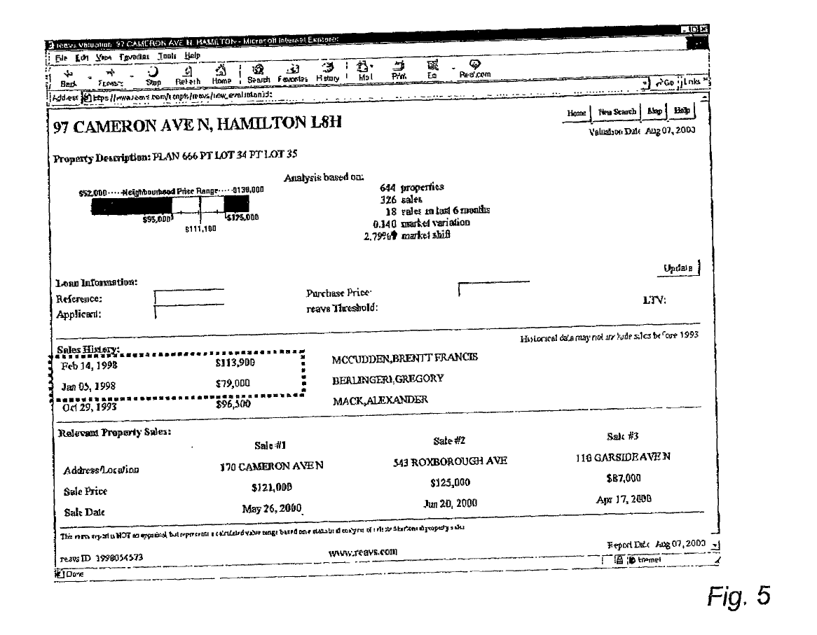

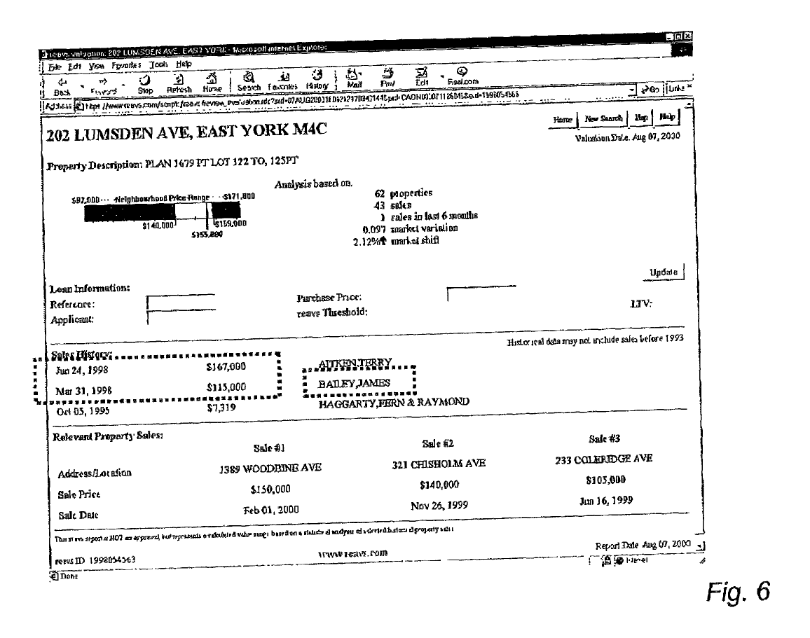

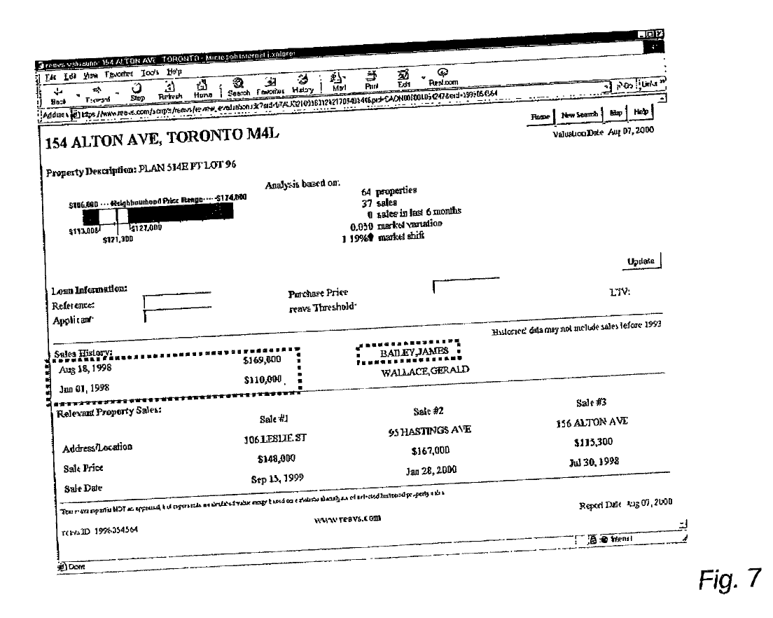

Property Flip detected: This flag indicates that a pattern associated with a property flip as defined by the lender has been found in the past sales transactions associated with the subject property. In general, this means that 2 transactions of the same property have been registered, within a given period, where the value of the property changed significantly, as shown in the highlighted portions of FIGS. 4 to 7. As an example, a flip could be defined as a $30,000 difference between 2 sales within a 6-month period.

There are many situations on file that satisfy the above criteria, but which most certainly would not be considered part of any fraudulent activity. For example, virtually every newly built property which is sold to first time buyers, from the original builder, can be defined as a flip under the above definition. These can be identified separately if desired, but will typically NOT be flagged as a flip. For the purposes of defining these builder transactions, the seller name must match to a list of known builders, and the transactions must be the first on record for the subject property.

The flip definition can be customized by the lender or the client of the system of the invention. There are several other criteria that have been identified which are used to eliminate “false positives”.

Flips in Area: Flags an unusually high proportion of properties in the neighborhood with a history of flips.

Possible Rental Property: Flags evidence on file that this property is not currently owner-occupied. This flag is set if the property address is not the same as the property owner's address.

Inconsistent High Sale on Record: Flags that a registered sale of the property which is inconsistently high has been found, based on the historical sales data of the system database.

Inconsistent DMV (Declared Market Value): Flags that the property value in the mortgage application is inconsistent, based on the inconsistency check described below.

The above flag indicates a potential fraudulent exposure, which means a possible overexposure due to high declared property values, the requested loan amount, and risk policy.

Risk policy and charges are often determined based on a loan-to-value (LTV) ratio. For example, there will certainly be different lending criteria, or insurance premiums based on a 50% LTV loan vs. an 80% LTV loan. At each different level, a certain amount of exposure is acceptable. For the purposes of this flag, the property value necessary to guarantee compliance to lending/insurer policy is calculated. This flag indicates that the necessary property value (NOT the value declared) is inconsistent. For example, if the application was for $100,000 and the loan approval was based on a LTV of 85%, the necessary property value for the loan would be (100000/0.85) or $117,647.

This flag is focused more on refinancing than purchases, and is intended to eliminate false positives. Experience has shown that owners tend to overvalue their property when refinancing, even to the point that it's questionable. However, in many cases, the actual loan requested is easily supported by a lower, more realistic property value. There is little benefit to flagging such transactions as fraud.

Owner Name Mismatch: Flags that the registered property owner name does not match the applicant or seller's name. Based on the transaction type, the check is against either the applicant name, or the seller in the mortgage application against the property owner. In other words, this flag indicates the name of the seller does not match any of the names of the registered property owner.

Suspicious Applicant Name: Flags that the applicant name matches a suspicious name in the area under consideration.

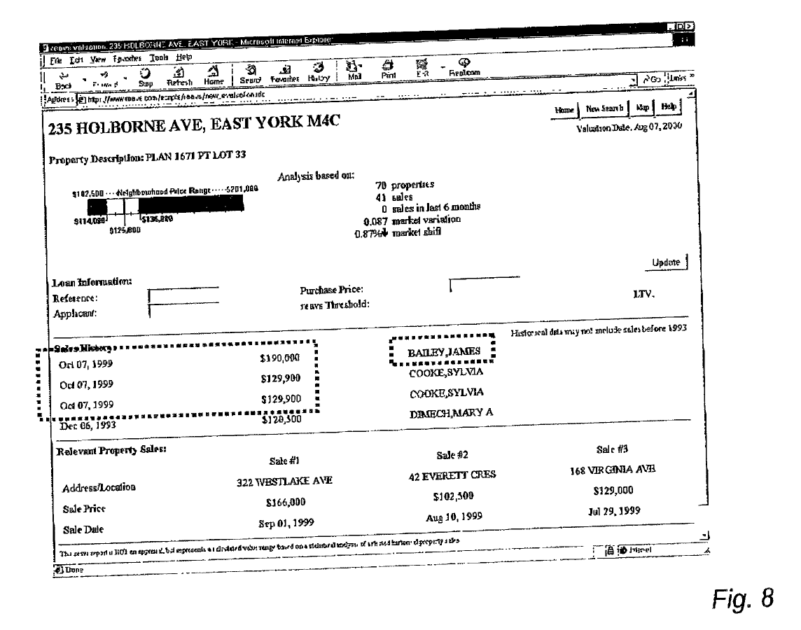

Suspicious Seller Name: Indicates that the seller's name matches a suspicious name derived from transactions within the area. Further, this flag indicates that the buyer or seller appears unusually frequently as a participant in sales transactions within this area. As shown in FIGS. 4, 6-8, the name “Bailey, James” is frequently posted in sales history records of different properties. In the figures, the area covered is a municipality, and a separate list of “suspicious” names can be maintained for each area, based on the transactions on file.

A database of suspicious names can be maintained by area. This database will be added to as inconsistently high sales and property flips are determined from the property and sales database. This database can include names of other participants in mortgage transactions, such as brokers, counsel, or the like, and flags can be derived from checking participant's names included with each application's data against this database.

Due to the nature of the data flow into the database in a preferred embodiment of the invention it may be difficult to flag all flips instantaneously. To deal with this, a follow-up audit may be instituted. For example, on a regular basis, (generally monthly), as sales data becomes available, a special processing query may be directed to all of the latest posted sales to determine if, based on the new information, there are any properties which have a new or changed “flipped” status. The list of any properties newly flagged as potential flips may be made available to the lenders or the clients of the system and may be processed against their portfolios.

This process is intended to provide a regular audit of potential fraudulent situations and to trigger subsequent investigative action by each lender or client. While these loans may already be funded, it is intended to flag potentially high-risk situations as soon as possible based on the availability of the data trails, and to eliminate repetitive schemes.

The system is intended to provide two separate data feeds to lenders: the first signals any red flags detected based on details for a specific loan application, and the second is a regular audit file which contains details of any suspicious market activity.

Referring to FIGS. 2 and 3, an audit is conducted of property transactions that have taken place among multiple properties and then compares property transaction data with data from a database to determine if potential fraud indicators are present. In a preferred embodiment, the actual interface between the mortgage lender 230 and the system 200 and database 210 is automatically sent to the system 200 through a direct electronic data link from the financial institution's lending system, thereby eliminating any possibility that the fraud detection step can be skipped.

Each mortgage lender 230 can implement its own procedures to deal with any red flags that occur as part of its normal lending process. The system 200 of the invention provides for customized messages or instructions to the loan representative to indicate how to proceed with a red flagged situation. The system can be designed such that particular red flags are notified to a certain specific representative only. Some may choose to have multiple departments within the institution signalled, and/or to require multiple signoffs, to mitigate against internal collusion.

The “raw” data necessary to implement the system as contemplated herein is available from a variety of sources, both public and commercially. Sources will vary based on the jurisdiction, and who is implementing the system. Indeed, one of the benefits of the system is that it contains data pulled from a variety of sources and makes it available through a consistent standardized model.

The property values carried in the Property database can be taken and maintained based on AVM technology, or from tax assessments.

On-going sales data is available through public registries.

Normalization: Normalization is the term used herein to define a standard for dealing with names and addresses which focuses on providing a mechanism to match records. Without such a standard, it is very difficult, if not impossible, to match data records coming from different sources to common elements. The standards are not the same for addresses as for names, and the standards may change again based on language and geography.

While is outside of the scope of this document to define a normalization standard, such standards are necessary for the invention. There are standards defined by various public bodies, and these can be adapted if desired. There are also advantages to a custom definition.

Address Normalization: The purpose of address normalization is to effectively and positively match information or data records originating from different sources, and this can be difficult. For this invention, the need is to define a standard that is specific to matching residential properties within many jurisdictions, across languages. In addition, many times a residential property can be addressed by multiple street names, and hence some aliases may be necessary.

Name Normalization: In the same way that the form of addresses needs be standardized in order to match and compare them, people names have the same need for a standardized form.

The invention requires that information be analysed within a geographic context, and the property table requires a neighbourhood classification.

The use of a GIS or Geographic Information System will most likely be necessary to specify the geographic attributes of properties. Through a process called geocoding, properties are assigned longitude and latitude (X,Y) coordinates based on their address, and from there, municipality and neighbourhoods can be categorized.

In some cases, data may be available that already has such classifications.

Neighborhoods: In the invention, each property is classified by a neighbourhood code, which is assigned to be able to identify those properties which are physically close to each other. In a preferred embodiment, these neighbourhoods should identify nearby groups of homogeneous properties, with at least several hundred properties within each neighbourhood.

Consistent Sales: A key processing requirement in the system is the ability to filter out sales that are inconsistent within a geographic neighbourhood. This processing is used in several ways through the invention. The general methodology used to accomplish this is described herein, based on a sales file that has been set up as earlier discussed.

To determine whether a particular sale transaction is consistent:

1. Select all sales within the same neighbourhood of the same property type, where the sale price is greater than some lower limit (i.e. $10,000) and for each selected sales record, calculate the STV, or ratio of the actual sales amount to the property value (Sale To Value). The actual value of the STV is of minor interest. In any public registry of sales, there will be many records with a low dollar amount (many times $1 or $2 ) and these need be eliminated.

2. Depending on the number of records available, it may be desirable to select records based on the date of sale, such as limiting records to those registered within the last 2 years.

3. Sort the resulting records by the STV, in ascending order. This will produce a set of sales records with a range of STV's, but most will be relatively the same, with a few much lower, and a few much higher than the rest.

4. Starting from the median record, scan up and down the data set, calculating the relative difference between subsequent records in the sorted data set, and stop when the absolute difference between subsequent STV's is greater than 2%.

So, if there were 200 records in the sorted data set, begin at record 100, and calculate the relative difference between the STV's of record 100, and record 101, as abs(((STV_record101_STV' record 100)/STV'record 100)). If this is less than 0.02, then carry on to the next two subsequent records, 101 and 102. If the measured difference is greater than 0.02, then stop the scanning-the SVR measured from the previous step provides an upper limit for consistency purposes, and will be referred to as MAX'sTV.

In a similar fashion, scanning can proceed down the sorted list, beginning with record 99 and 100, then 98 and 99, and so on until the relative difference between the STV's is greater than .02, resulting in a MIN'sTV.

5. To determine whether the particular sale is consistent, calculate its STV and check whether the STV is no less than the MIN'sTV and no more than the MAX'sTV.

This method provides a general way of calculating a limit to determine whether a particular sale is consistent with market activity within a specific neighbourhood, specific to the property type. The relative limit described above of .02, has been found to be generally applicable, but may need to be adjusted based on the accuracy of the property values used in the model.

In practise, the MAX'sTV value is best calculated from the raw sales records each time it is required.

The actual value of MAX'sTV will vary quite a bit based on the underlying property values used, the neighbourhood and the marketplace.

While this invention has been described with reference to several specific embodiments, the description is illustrative of the invention and is not to be construed as limiting the invention. Various modifications and variations may occur to those skilled in the art without departing from the true spirit and scope of the invention as defined by the appended claims.

What is claimed is:

1. In processing a mortgage application, where a real property is presented as collateral by the mortgage applicant, a method of preventing a mortgage fraud by using a computer system, the method comprising the steps of:
(a) maintaining a database in the computer system, the database containing data regarding a plurality of real properties, the data including an identification, a valuation, and a historical market activity associated with each real property;
(b) providing information on the mortgage application to the computer system; and
(c) analysing the information provided from the mortgage application and the data in the database to search for any abnormal situation therein, which may constitute a potential mortgage fraud scheme;
(d) wherein, when the abnormal situation is flagged, measures can be taken to prevent a mortgage fraud from occurring.

2. A method according to claim 1, wherein a geographic information system is incorporated into the computer system, thereby supporting a geographic identification of each real property.

3. A method according to claim 1, wherein the historical market activity data includes historical sales-related information, and previous financing and refinancing information of each real property, together with the participants' names.

4. A method according to claim 1, wherein the database further includes a list of suspicious names, which is updated consistently whenever an abnormal situation is flagged or a mortgage fraud is reported.

5. A method according to claim 1, wherein the information provided from mortgage applications is stored in the database as data thereof.

6. A method according to claim 1, wherein the step of maintaining the database includes a step of receiving from a plurality of mortgage lenders information necessary for establishing and updating the database.

7. A method according to claim 6, wherein the step of maintaining the database further includes a step of receiving from an automated valuation model (AVM) system information necessary for establishing and updating the database.

8. A method according to claim 7, wherein the step of maintaining the database further includes a step of receiving from a property tax-related organization information necessary for establishing and updating the database.

9. A method according to claim 1, wherein the database is updated continuously or on a regular basis.

10. A method according to claim 1, wherein the abnormal situation is identified by detecting data patterns similar to data patterns determined from known cases of fraudulent activities.

11. A method according to claim 1, wherein the abnormal situation is flagged when multiple mortgage applications are involved with respect to a single real property, and the difference between the property values declared by the applicant of each application meets a predetermined criteria.

12. A method according to claim 3, wherein the abnormal situation is flagged when two or more sales transactions are detected for a single real property and the difference between the sale prices meets a predetermined criteria.

13. A method according to claim 1, wherein the abnormal situation is flagged when the property address in the mortgage application mismatches the property owner's address.

14. A method according to claim 3, wherein the abnormal situation is flagged when the sale price is inconsistently high.

15. A method according to claim 1, wherein the abnormal situation is flagged when the declared property value in the mortgage application is inconsistently high.

16. A method according to claim 1, wherein the abnormal situation is flagged when the declared property value or the requested loan amount from the mortgage application is unreasonably high.

17. A method according to claim 1, wherein the abnormal situation is flagged when the registered property owner name mismatches the applicant's name or the seller name on the mortgage application.

18. A method according to claim 4, wherein the abnormal situation is flagged when the applicant name or the seller name matches one of the suspicious names.

19. A method of preventing a mortgage fraud by using a computer system, the method comprising steps of:
(a) maintaining a database in the computer system, the database containing data regarding a plurality of real properties, the data including an identification data, a valuation data, and a data of historical market activities associated with each real property;
(b) analysing the data to flag abnormal situations therein, which constitute a potential mortgage fraud; and
(c) providing a list of real properties containing flags.

20. A method according to claim 19, further comprising a step of distributing the list of real properties containing the flags to a plurality of mortgage lenders.

21. A method according to claim 19, wherein the data analyzing step is carried out on a regular basis.

22. A method according to claim 19, wherein a geographic information system is incorporated into the computer system, thereby supporting a geographic identification of each real property.

23. A method according to claim 22, wherein the data analyzing step is carried out on the basis of geographic area or neighbourhood.

24. A method according to claim 19, wherein the abnormal situation is flagged by considering a data pattern determined from known cases of fraudulent activities.

25. A method according to claim 19, wherein the abnormal situation is flagged when two or more sales transactions for the same real property are detected and the difference between the sale prices meets a predetermined criteria.

26. A method according to claim 19, wherein the abnormal situation is flagged when a sale price is inconsistently high.

27. A method according to claim 19, wherein the database further includes a list of suspicious names, which is updated consistently whenever an abnormal situation is flagged or a mortgage fraud is reported.

28. A method according to claim 27, wherein the abnormal situation is flagged when a seller or purchaser name of a sales transaction matches one of the suspicious names.

29. A computer system for preventing a mortgage fraud, the system comprising:
(a) a database containing a data regarding a plurality of real properties, the data including an identification data, a valuation data, and a historical market activity data associated with each real property;
(b) means for analysing the data to search for an unacceptable situation therein, which may constitute a potential mortgage fraud; and
(c) means for providing a list of real properties containing flags.

30. A system according to claim 29, further comprising a plurality of mortgage lenders' systems communicatively connected with the system via a communications network.

31. A system according to claim 30, wherein information associated with a loan application is provided from the mortgage lender to the system; and further comprising:
(a) means for analysing the information provided from the loan application by the lender and the data in the database to search for an unacceptable situation therein, which may constitute a potential mortgage fraud scheme; and
(b) means for informing the corresponding mortgage lender of the analysis result, when any unacceptable situation is flagged, thereby enabling the lender to take measures to prevent a mortgage fraud from occurring.

32. A system according to claim 30, wherein the lender's system receives via the communications network the list of real properties containing flags.

33. A system according to claim 30, wherein the lenders' systems provide via the communications network information necessary for updating the database.

34. A system according to claim 29, further comprising a plurality of real property-related organizations via a communications network for exchanging relevant information.

35. In processing a mortgage application, where a real property is presented as collateral, a method of preventing a mortgage fraud, the method comprising the steps of:
(a) receiving information on a mortgage application from a mortgage lender;
(b) providing the received information to a computer system, the computer system having a database containing data regarding a plurality of real properties, the data including an identification, a valuation, and a historical market activity associated with each real property;
(c) analyzing the information to flag abnormalities; and
(d) sending any flag to the mortgage lender.
